(19) United States
(12) Patent Application Publication
(10) Pub. No.: US 2025/0289197 A1
(43) Pub. Date: Sep. 18, 2025

(54) METHOD OF MANUFACTURING INFUSION BAG

(71) Applicant: FUJIFILM Corporation, Tokyo (JP)

(72) Inventor: Yoshiki SAKAZAKI, Minamiashigara-shi (JP)

(73) Assignee: FUJIFILM Corporation, Tokyo (JP)

(21) Appl. No.: 19/224,999

(22) Filed: Jun. 2, 2025

Related U.S. Application Data
(63) Continuation of application No. PCT/JP2024/000984, filed on Jan. 16, 2024.

(30) Foreign Application Priority Data
Jan. 27, 2023 (JP) 2023-011146

(51) Int. Cl. B29D 22/00; A61J 1/10; A61J 1/14; B29K 705/00

(52) U.S. Cl. CPC B29D 22/003; A61J 1/10; A61J 1/1468; B29K 2705/00

(57) ABSTRACT

An object is to provide a method of manufacturing an infusion bag where one surface is covered with a metal barrier film and the other surface is covered with an organic/inorganic lamination type barrier film, in which damage of an inorganic layer can be prevented, and a barrier film can be appropriately bonded to the infusion bag body. Accommodation parts for accommodating the content of an infusion bag body that is sealed with a strong sealed portion and includes the accommodation parts separated by a weak sealed portion are placed on a first placement table and are covered with a metal barrier film having a concave portion to bond peripheral portions. Next, the strong sealed portion and the weak sealed portion are placed on a second placement table having a space for accommodating the concave portion and are covered with a lamination type barrier film to bond peripheral portions. As a result, the object is achieved.

### CROSS-REFERENCE TO RELATED APPLICATIONS

This application is a Continuation of PCT International Application No. PCT/JP2024/000984 filed on Jan. 16, 2024, which claims priority under 35 U.S.C. § 119(a) to Japanese Patent Application No. 2023-011146 filed on Jan. 27, 2023. The above applications are hereby expressly incorporated by reference, in their entirety, into the present application.

### BACKGROUND OF THE INVENTION

### 1. Field of the Invention

The present invention relates to a method of manufacturing an infusion bag. Specifically, the present invention relates to a method of manufacturing an infusion bag where a barrier film is bonded to both surfaces to prevent deterioration of the content caused by water or the like.

### 2. Description of the Related Art

An infusion bag for accommodating a drug that is denatured by water or oxygen is required to have high gas barrier properties from the viewpoint of improving storage stability of a drug or the like.
Accordingly, in the infusion bag that is required to have gas barrier properties, the gas barrier properties are improved by bonding a barrier film (gas barrier film) to the surface.

As the barrier film having high gas barrier properties, an organic/inorganic lamination type barrier film where a barrier layer having a laminated structure of an organic layer and an inorganic layer is provided on a support such as a resin film is known.
In the organic/inorganic lamination type barrier film, the inorganic layer mainly exhibits gas barrier properties. On the other hand, the organic layer acts as an underlying layer for forming the appropriate inorganic layer and as a protective layer for protecting the inorganic layer. As a result, in the organic/inorganic lamination type barrier film, the appropriate inorganic layer can be stably formed, and damage of the inorganic layer that exhibits gas barrier properties can be prevented. Therefore, very high gas barrier properties can be obtained.

For example, JP2012-075716A discloses an infusion bag including: a resin bag consisting of a resin film including polyethylene and/or polypropylene; and a barrier layer provided on at least one surface of the resin bag, in which the barrier layer has a structure in which a first organic layer, an inorganic layer, and a second organic layer mutually adjoin in this order.
In the infusion bag described in JP2012-075716A, the barrier film where the barrier layer is provided on the support (plastic film) is prepared, a sealant layer consisting of the same resin film as that of the resin bag adheres to the barrier film, and the sealant layer is thermally welded (heat-sealed) to the resin bag to bond the barrier film to the infusion bag.

Regarding the barrier film including the laminated barrier layer where the organic layer and the inorganic layer are laminated, by selecting a material for forming the inorganic layer, a barrier film having not only gas barrier properties but also excellent light transmittance (transparency) can be obtained.
Accordingly, by using the barrier film including the barrier layer having excellent light transmittance, the content of the infusion bag is visible.

Here, in a case where the barrier film including the inorganic layer having low toughness is bonded to one surface of the infusion bag, it is preferable that a film having bend resistance is bonded to the opposite surface.
For example, JP2015-080871A describes an infusion bag where one or multiple sealing function layers consisting of a vapor deposited film or the like of an inorganic oxide are provided on one surface of the infusion bag and a bend-resistant function film including an aluminum layer on a substrate film layer adheres to the other surface of the infusion bag. Both of the sealing function layer and the bend-resistant function film have excellent gas barrier properties, and can prevent deterioration of the content of the infusion bag caused by water or the like.

Incidentally, as the infusion bag, an infusion bag described in JP2019-037663A having a configuration where two accommodation parts are separated from each other by a weak sealed portion is also known. In the infusion bag including the two accommodation parts, for example, one accommodation part accommodates a powdered drug, and the other accommodation part accommodates saline or the like. In this infusion bag, by pressing the liquid accommodation part before use to fracture the weak sealed portion, the liquid and the powdered drug are mixed to be used as a liquid drug.
Even in the infusion bag including the two accommodation parts, for example, in a case where the powdered drug is weak to water, it is considered to bond a barrier film to both surfaces of the accommodation part. Here, as described above, by bonding a barrier film having excellent light transmittance that includes an inorganic layer or the like to one surface and bonding a non-light-transmitting barrier film that includes a metal thin film or the like to the other surface to obtain a uniform non-light-transmitting surface, the dissolution state of the powdered drug is easily checked.

### SUMMARY OF THE INVENTION

In the barrier film where the barrier layer includes the inorganic layer, for example, in the organic/inorganic lamination type barrier film, the inorganic layer mainly exhibits gas barrier properties.
Accordingly, in an infusion bag formed of the barrier film where the barrier layer includes the inorganic layer, in order for the barrier film to exhibit desired gas barrier properties, it is important that cracking, breakage, peeling, and the like do not occur in the inorganic layer.
To that end, it is preferable that the barrier film including the inorganic layer is bonded to the infusion bag in a state of being as planar as possible.

Incidentally, the bonding of the barrier film to the infusion bag is typically performed in a state where the content is accommodated.
Therefore, the infusion bag has a thickness corresponding to the content in the accommodation part, that is, has a three-dimensional shape. Thus, it is difficult to bond the barrier film to the infusion bag in a state of being as planar as possible.

It is also considered to bond the barrier film that is planarized by pressing the center of the infusion bag (accommodation part).
However, in this method, in a case where the barrier film is bonded to the periphery of the accommodation part by thermal welding as in JP2012-075716A, heat of a member that performs the thermal welding is transferred to a member that presses down the infusion bag. As a result, the temperature of the member that presses down the infusion bag increases, and fracture of the barrier film, deterioration of the content of the infusion bag, and the like may occur due to the heat.
Therefore, in a case where the barrier film is bonded to the infusion bag, it is difficult to press down portions other than the bonded portion.

In addition, in a state where one surface of the infusion bag is planar, in a case where the other surface of the infusion bag having a swelling three-dimensional shape is covered with the barrier film to bond the periphery, wrinkles are formed in the bonded portion of the barrier film. In a case where wrinkles are formed in the bonded portion of the barrier film, water or the like permeates from the wrinkles, there is also a case where sufficient gas barrier properties cannot be obtained.

An object of the present invention is to provide a method of manufacturing an infusion bag where one surface is covered with a metal barrier film including a metal layer and the other surface is covered with a lamination type barrier film having a laminated structure of an organic layer and an inorganic layer to prevent the content from deteriorating due to water or the like, in which damage of the inorganic layer of the lamination type barrier film can be prevented and the periphery of the barrier film can be appropriately bonded to the infusion bag body.

In order to achieve the object, the present invention has the following configurations.
[1] A method of manufacturing an infusion bag including an infusion bag body that is sealed with a strong sealed portion, includes two accommodation parts separated by a weak scaled portion, and accommodates a content in at least one of the accommodation parts, a metal barrier film that covers one surface of a to-be-barriered accommodation part as one of the accommodation parts for accommodating the content and includes a metal layer, and a lamination type barrier film that covers another surface of the to-be-barriered accommodation part and has a laminated structure of an organic layer and an inorganic layer, the method comprising:
a step of using the metal barrier film having a peripheral portion that is planar and having a concave portion that is shaped in a shape accommodating the to-be-barriered accommodation part to place the to-be-barriered accommodation part of the infusion bag body and the strong sealed portion and the weak sealed portion that surround the to-be-barriered accommodation part on a first placement table and to cover the to-be-barriered accommodation part with the concave portion of the metal barrier film;
a step of bonding the metal barrier film to the infusion bag body to surround the to-be-barriered accommodation part;
a step of placing the strong sealed portion and the weak sealed portion that surround the to-be-barriered accommodation part of the infusion bag body on a second placement table having a space into which the concave portion of the metal barrier film is inserted such that the metal barrier film side faces the second placement table side, and covering a surface of the to-be-barriered accommodation part opposite to the metal barrier film with the lamination type barrier film; and
a step of bonding the lamination type barrier film to the infusion bag body to surround the to-be-barriered accommodation part.
[2] The method of manufacturing an infusion bag according to [1],
in which at least one of the bonding of the metal barrier film and the infusion bag body or the bonding of the lamination type barrier film and the infusion bag body is performed by welding.
[3] The method of manufacturing an infusion bag according to [1] or [2],
in which the first placement table is planar.
[4] The method of manufacturing an infusion bag according to any one of [1] to [3],
in which the first placement table includes a peripheral flat portion and a convex portion rising from the flat portion, and
the metal barrier film is bonded to the infusion bag body to surround the to-be-barriered accommodation part in the flat portion.
[5] The method of manufacturing an infusion bag according to any one of [1] to [3],
in which the first placement table includes a peripheral flat portion and a concave portion recessed from the flat portion,
the bonding of the lamination type barrier film and the infusion bag body is performed using a rectangular frame such that the metal barrier film is bonded to the infusion bag body to surround the to-be-barriered accommodation part in the flat portion, and
in a case where a maximum depth of the concave portion of the first placement table is represented by L [mm] and an inner distance between short sides of the rectangular frame is represented by W [mm], the following expression

$$L / W \leq 0.035$$

is satisfied.
[6] The method of manufacturing an infusion bag according to any one of [1] to [5],
in which the metal barrier film having the concave portion is molded by any one of vacuum molding, embossing molding, blow molding, or injection molding.
[7] The method of manufacturing an infusion bag according to any one of [1] to [6],
in which a pin for positioning the infusion bag body is provided on at least one of the first placement table or the second placement table.

An object of the present invention is to provide a method of manufacturing an infusion bag where one surface is covered with a metal barrier film including a metal layer and the other surface is covered with a lamination type barrier film having a laminated structure of an organic layer and an inorganic layer, in which damage of the inorganic layer of the lamination type barrier film can be prevented and the periphery of the barrier film can be appropriately bonded to the infusion bag body.

### BRIEF DESCRIPTION OF THE DRAWINGS

FIG. 1 is a diagram conceptually showing an example of an infusion bag manufactured using a method of manufacturing an infusion bag according to the present invention.

FIG. 2 is a diagram conceptually showing a cross section taken along line II-II of FIG. 1.

FIG. 3 is an enlarged view conceptually showing a part of FIG. 1.

FIG. 4 is a conceptual diagram showing the method of manufacturing an infusion bag according to the present invention.

FIG. 5 is a conceptual diagram showing the method of manufacturing an infusion bag according to the present invention.

FIG. 6 is a diagram conceptually showing an example of a first placement table.

FIG. 7 is a diagram conceptually showing another example of the first placement table.

### DESCRIPTION OF THE PREFERRED EMBODIMENTS

Hereinafter, a method of manufacturing an infusion bag according to an embodiment of the present invention will be described in detail based on preferred examples shown in the accompanying drawings.

In the present invention, numerical ranges represented by “to” include numerical values before and after “to” as lower limit values and upper limit values.
Further, all the drawings described below are conceptual views for describing the present invention. Accordingly, a size, a thickness, a shape, a positional relationship, and the like of each of members are different from the actual ones.

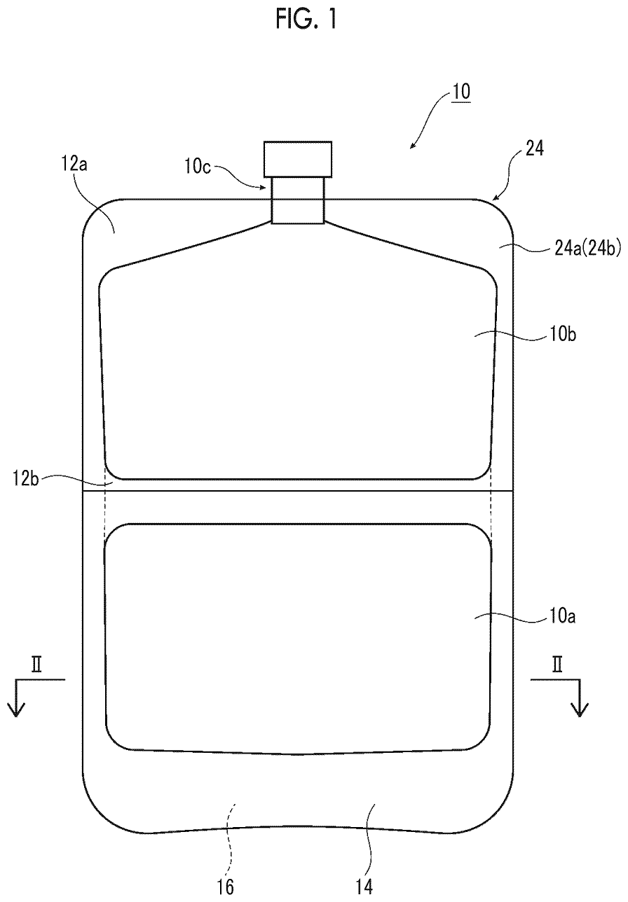

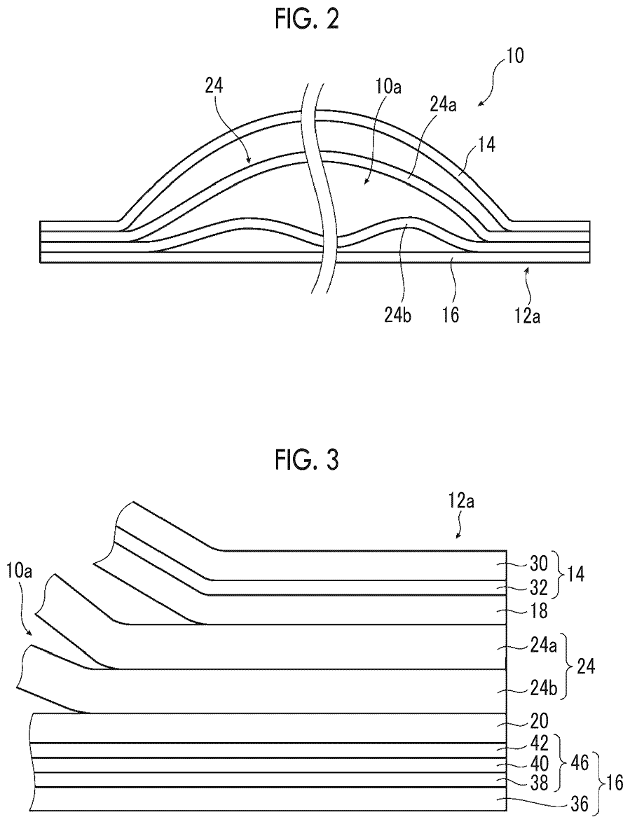

FIG. 1 is a diagram conceptually showing an example of an infusion bag manufactured using the method of manufacturing an infusion bag according to the embodiment of the present invention. In addition, FIG. 2 is a diagram conceptually showing a cross section of the infusion bag taken along line II-II of FIG. 1.
All the members shown in FIG. 2 and FIG. 3 described below are cross sections. Therefore, in order to simplify the drawings to clearly show the configuration, the cross section is not hatched.

As shown in FIGS. 1 and 2, in the infusion bag 10, one surface of an infusion bag body 24 is covered with a metal barrier film 14, and the other surface is covered with a lamination type barrier film 16.

The infusion bag body 24 is a bag body forming a well-known infusion bag for a medical use where two resin films including a resin film 24a and a resin film 24b having the same shape that is substantially rectangular are laminated and peripheral portions thereof are bonded and sealed through a strong sealed portion 12a.
In addition, in the infusion bag body 24, the bag body that is formed by sealing the peripheral portions with the strong sealed portion 12a is separated into two accommodation parts including a first accommodation part 10a and a second accommodation part 10b by a weak sealed portion 12b.
A port 10c for discharging the content before use of the infusion bag 10 is inserted into the second accommodation part 10b.
In the manufacturing method according to the embodiment of the present invention, the number of accommodation parts is not limited to two as long as the infusion bag body includes two accommodation parts separated by the weak sealed portion 12b. The infusion bag body may include three or more accommodation parts separated by the weak sealed portion 12b.

In the infusion bag body 24, in the strong sealed portion 12a of the peripheral portions, the two resin films are bonded to each other through a strong bonding strength, and the resin film 24a and the resin film 24b are not basically peeled off from each other.
On the other hand, in the weak sealed portion 12b that separates the first accommodation part 10a and the second accommodation part 10b from each other, the bonding strength is slightly weak, and the first accommodation part 10a and the second accommodation part 10b are fractured by being pressed. This weak sealed portion 12b may be formed using a well-known method corresponding to the method of bonding the resin film 24a and the resin film 24b.
In the infusion bag 10 including the infusion bag body 24, for example, the first accommodation part 10a accommodates a powdered drug, and the second accommodation part 10b accommodates saline or the like. In the infusion bag 10, for example, by pressing the second accommodation part 10b immediately before use to fracture the weak sealed portion 12b by a pressure of the saline or the like, the powdered drug and the saline are mixed and used as a liquid drug (chemical liquid).

The content accommodated in the infusion bag manufactured using the manufacturing method according to the embodiment of the present invention is not limited to the powdered drug and saline, and various well-known contents that are accommodated in an infusion bag including two accommodation parts can be used. The infusion bag including two accommodation parts is also called a W bag.

In the infusion bag 10 in the example shown in the drawing, for example, the metal barrier film 14 and the lamination type barrier film 16 are provided to cover the first accommodation part 10a for accommodating the powdered drug. That is, in the example shown in the drawing, the first accommodation part 10a is the to-be-barriered accommodation part according to the embodiment of the present invention.
The peripheral portions of the metal barrier film 14 and the lamination type barrier film 16 are bonded to the strong sealed portion 12a and the weak sealed portion 12b of the infusion bag body 24 to surround the first accommodation part 10a.

Although not shown in FIG. 2, in the infusion bag 10 in the example shown in the drawing, a sealant layer 18 is bonded to the entire surfaces of the metal barrier film 14 and the lamination type barrier film 16 on the infusion bag body 24 side (refer to FIG. 3).
In the infusion bag 10, the peripheral portions of the metal barrier film 14 and the lamination type barrier film 16 are bonded to the strong sealed portion 12a and the weak sealed portion 12b of the infusion bag body 24 by thermal welding (heat sealing) using the sealant layer 18.
The above-described point will be described below.

FIG. 3 conceptually shows the strong sealed portion 12a that forms the first accommodation part 10a of the infusion bag 10. FIG. 3 shows the strong sealed portion 12a that forms the first accommodation part 10a. The weak sealed portion 12b that forms the first accommodation part 10a also has basically the same configuration, except that the sealing strength is different.
In the following description, the strong sealed portion 12a and the weak sealed portion 12b that form the first accommodation part 10a will also be referred to as “the strong sealed portion 12a and the weak sealed portion 12b of the first accommodation part 10a”.
The resin film 24a and the resin film 24b forming the infusion bag body 24 are bonded to each other through the strong sealed portion 12a to form the infusion bag body 24.
As described above, the inside of the infusion bag body 24 is divided into the first accommodation part 10a and the second accommodation part 10b by the weak sealed portion 12b.

The infusion bag 10 in the example shown in the drawing is substantially rectangular, and the first accommodation part 10a and the second accommodation part 10b separated by the weak sealed portion 12b are substantially rectangular. That is, as shown in FIG. 1, the first accommodation part 10a and the second accommodation part 10b having a bag shape are formed by the common weak sealed portion 12b of one side and the strong sealed portion 12a of three sides.

The sealant layer 18 is bonded to the entire surfaces of the metal barrier film 14 and the lamination type barrier film 16 on the infusion bag body 24 side. Although shown in FIG. 2, the sealant layer 18 is as described above.
The metal barrier film 14 is thermally welded to the strong sealed portion 12a and the weak sealed portion 12b of one surface of the first accommodation part 10a through the sealant layer 18. In addition, the lamination type barrier film 16 is thermally welded to the strong sealed portion 12a and the weak sealed portion 12b of the other surface of the first accommodation part 10a through the sealant layer 18.
As a result, the metal barrier film 14 and the lamination type barrier film 16 are bonded to the infusion bag body 24 to surround the first accommodation part 10a.

As shown in FIG. 3, in the infusion bag 10 in the example shown in the drawing, in the metal barrier film 14, a metal layer 32 is laminated on a support 30.
On the other hand, in the lamination type barrier film 16, a laminated barrier layer 46 where an underlying organic layer 38, an inorganic layer 40, and a protective organic layer 42 are laminated is laminated on a support 36.

In the infusion bag 10 manufactured using the manufacturing method according to the embodiment of the present invention, as described above, the infusion bag body 24 is a bag body forming a well-known infusion bag for a medical use where the peripheral portions of two resin films including the resin film 24a and the resin film 24b having the same shape that are laminated are sealed through the strong sealed portion 12a and the inside thereof is divided into two bag bodies by the weak sealed portion 12b.
The shape (planar shape) of the infusion bag body 24, that is, the resin film 24a and the resin film 24b is typically substantially rectangular.
In addition, as a method of bonding and sealing the resin film 24a and the resin film 24b in the strong sealed portion 12a and the weak sealed portion 12b, a well-known method can be used, and examples thereof include adhesion using an adhesive and thermal welding.

As the resin film 24a and the resin film 24b, a thermally weldable (heat sealable; thermally fusible) film is suitably used. That is, it is preferable that the infusion bag body 24 is formed by thermally welding.
Examples of the resin film 24a and the resin film 24b include a film consisting of polyolefin such as polyethylene (PE) or polypropylene (PP) and a film consisting of polyvinyl chloride.

The thickness of the resin film 24a and the resin film 24b forming the infusion bag body 24 is not limited, and may be appropriately set depending on the size of the infusion bag 10, the kind of the content, and the like such that a sufficient strength as a bag body for accommodating the content can be obtained.
The thickness of the resin film 24a and the resin film 24b is preferably 20 to 200 μm.

As described above, in the metal barrier film 14, the metal layer 32 is laminated on the support 30. In the metal barrier film 14, the metal layer 32 acts as a barrier layer.

As the metal barrier film 14, various well-known laminates where a metal layer is laminated on a support that are used as a barrier film (gas barrier film) can be used.

Note that, in a case where the metal layer 32 is sufficiently thick and has a sufficient mechanical strength or the like, the metal barrier film does not need to include the support 30.

In the metal barrier film 14, the support 30 supports the metal layer 32. The support 30 is not particularly limited, and various well-known sheet-shaped materials (plate-shaped materials, films, or layers) can be used.
As the support 30, for example, a sheet consisting of a resin material is suitably used.
Examples of the resin material for forming the support 30 include polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, polymethyl methacrylate resin (PMMA), polycarbonate (PC), polyacrylate, polymethacrylate, polypropylene (PP), polystyrene (PS), an acrylonitrile-butadiene-styrene copolymer (ABS), a cycloolefin copolymer (COC), a cycloolefin polymer (COP), triacetyl cellulose (TAC), an ethylene-vinyl alcohol copolymer (EVOH), and nylon.

The thickness of the support 30 is not limited, and may be appropriately set depending on the forming material such that the metal layer 32 can be supported.
The thickness of the support 30 is preferably 20 to 500 82 m.

The metal layer 32 is laminated on the support 30.
The metal layer 32 is not limited, and various well-known metal layers (metal barrier layers) that can be used as a barrier layer for a barrier film (gas barrier film) can be used.
Examples of the metal layer 32 include metal layers consisting of aluminum, magnesium, or an alloy including the above-described metal as a major component. In particular, for example, a metal layer consisting of aluminum or an alloy including aluminum as a major component can be suitably used.

In the metal barrier film 14, the thickness of the metal layer 32 is not limited and may be appropriately set depending on the material for forming the metal layer 32 such that the metal barrier film 14 can act as a barrier layer that exhibits required gas barrier properties and, in a case where the metal barrier film 14 is shaped in a convex shape described below, the shape can be maintained.
The thickness of the metal layer 32 is preferably 5 to 500 μm. The thickness of the metal layer 32 is preferably 5 μm or more from the viewpoints that, for example, the metal barrier film 14 can be suitably shaped, sufficient barrier properties can be obtained, and the formation of a pinhole during bending is avoidable. In addition, the thickness of the metal layer 32 is preferably 500 μm or less and more preferably 30 μum or less from the viewpoints that, for example, the weight of the metal barrier film 14, that is, the infusion bag 10 can be prevented from being unnecessarily increased, the flexibility as a container can be ensured, and communication caused by the fracture of the weak sealed portion can be easily performed.
As described above, in a case where the metal layer 32 has a sufficient thickness, the metal barrier film does not need to include a support. In this case, the surface of the metal layer 32 can also be made porous by anodization or the like such that the metal layer 32 and the sealant layer 18 can also be bonded without using a bonding agent described below.

As the metal barrier film 14, various well-known barrier films where the metal layer 32 as the barrier layer is laminated on the support 30 that can be used as a barrier film can be used.
Accordingly, in the metal barrier film 14, the metal layer 32 may be directly formed and laminated on the support 30 using a plating method such as melt plating or electroless plating or a vacuum film forming method (vacuum deposition method) such as vapor deposition, CVD, plasma CVD, or sputtering. Alternatively, in the metal barrier film 14, a metal film (metal foil) may be bonded to the support 30 using a bonding agent corresponding to the forming material to form the metal layer 32.
In addition, as the metal barrier film 14, a commercially available product can also be suitably used.
Further, in the manufacturing method according to the embodiment of the present invention, as described below, the metal barrier film 14 is shaped in a form including a concave portion that accommodates the first accommodation part 10a.

On the other hand, in the lamination type barrier film 16, the laminated barrier layer 46 is laminated on the resin film for forming the support 36.
The laminated barrier layer 46 is a laminated barrier layer where an organic layer and an inorganic layer are laminated, the laminated barrier layer including the underlying organic layer 38, the inorganic layer 40, and the protective organic layer 42 in this order from the support 36 side.

The laminated barrier layer 46 in the example shown in the drawing includes only one laminated structure of the underlying organic layer 38 and the inorganic layer 40, but the present invention is not limited thereto.
For example, in the infusion bag manufactured using the manufacturing method according to the embodiment of the present invention, the laminated barrier layer may include two laminated structures of the underlying organic layer 38 and the inorganic layer 40, the two laminated structures including the underlying organic layer 38, the inorganic layer 40, the underlying organic layer 38, and the inorganic layer 40 in this order from the support 36 side. In addition, in the present invention, the laminated barrier layer may include three laminated structures of the underlying organic layer 38 and the inorganic layer 40, the three laminated structures including the underlying organic layer 38, the inorganic layer 40, the underlying organic layer 38, the inorganic layer 40, the underlying organic layer 38, and the inorganic layer 40 in this order from the support 36 side. Further, in the present invention, the laminated barrier layer may have four or more laminated structures.
That is, in the infusion bag manufactured using the manufacturing method according to the embodiment of the present invention, the laminated barrier layer in the lamination type barrier film 16 can adopt various layer configurations as long as it includes one or more laminated structures of the underlying organic layer 38 and the inorganic layer 40 and preferably includes the protective organic layer 42 as the upper most layer.

In the present invention, the support 36 supports the laminated barrier layer 46, and a well-known sheet-shaped material (a film or a plate-shaped material) that is used as a support for various barrier films, various laminated functional films, and the like can be used.

A material of the support 36 of the lamination type barrier film 16 is not limited, and various materials can be used as long as the underlying organic layer 38 and the inorganic layer 40 can be formed.
As the support 36, for example, a resin film is suitably used. Specifically, the resin film consisting of the resin material described above as the example of the support 30 of the metal barrier film 14 can be used. In particular, a PET film is suitably used.

The thickness of the support 36 is not limited and may be appropriately set depending on the forming material such that the laminated barrier layer 46 can be supported, the mechanical strength of the lamination type barrier film 16 can be sufficiently ensured, and sufficient flexibility can be obtained.
The thickness of the support 36 is preferably 5 to 150 μm from the viewpoints that, for example, the mechanical strength of the lamination type barrier film 16 can be sufficiently ensured, the lamination type barrier film 16 having excellent flexibility can be obtained, and the weight and thickness of the lamination type barrier film 16 can be reduced.

In the lamination type barrier film 16, the underlying organic layer 38 is formed on one surface of the support 36.
The underlying organic layer 38 consists of, for example, an organic compound obtained by polymerization (crosslinking or curing) of a monomer, a dimer, an oligomer, or the like.

The underlayer of the inorganic layer 40, that is, the underlying organic layer 38 functioning as the formation surface of the inorganic layer 40 is an underlayer for appropriately forming the inorganic layer 40.
The underlying organic layer 38 formed on the surface of the support 36 embeds unevenness of the surface of the support 36, foreign matter attached to the surface, and the like to appropriately planarize the formation surface of the inorganic layer 40 such that the inorganic layer 40 can be appropriately formed.
As described above, in the present invention, the gas barrier layer may include a plurality of laminated structures of the inorganic layer 40 and the underlying organic layer 38. In this case, the second or subsequent underlying organic layer 38 is formed on the inorganic layer 40. Even in this configuration, the underlying organic layer 38 functioning as the underlayer of the inorganic layer 40 exhibits the same action. That is, the underlayer of the inorganic layer 40 is the formation surface of the inorganic layer 40.
In particular, by providing the underlying organic layer 38 on the surface of the support 36, the inorganic layer 40 that mainly exhibits gas barrier properties can be appropriately formed.

The underlying organic layer 38 is formed, for example, by curing a composition for forming an organic layer that includes an organic compound (a monomer, a dimer, a trimer, an oligomer, a polymer, and the like). The composition for forming an organic layer may include one kind or two or more kinds of organic compounds.
The underlying organic layer 38 includes, for example, a thermoplastic resin and an organic silicon compound. Examples of the thermoplastic resin include polyester, a (meth)acrylic resin, a methacrylic acid-maleic acid copolymer, polystyrene, a transparent fluororesin, polyimide, fluorinated polyimide, polyamide, polyamide imide, polyether imide, cellulose acylate, polyurethane, polyether ether ketone, polycarbonate, an alicyclic polyolefin, polyarylate, polyethersulfone, polysulfone, fluorene ring-modified polycarbonate, alicyclic-modified polycarbonate, fluorene ring-modified polyester, and an acrylic compound. Examples of the organic silicon compound include polysiloxane.

It is more preferable that the underlying organic layer 38 includes a (meth)acrylic resin including, as a major component, a monomer, a dimer, an oligomer, or the like of a bi- or higher functional (meth)acrylate such as dipropylene glycol di(meth)acrylate (DPGDA), trimethylolpropane tri(meth)acrylate (TMPTA), or dipentaerythritol hexa(meth)acrylate (DPHA), and it is still more preferable that the underlying organic layer 38 includes a (meth)acrylic resin including, as a major component, a polymer of a monomer or a polymer such as a dimer, an oligomer of a tri- or higher functional (meth)acrylate. In addition, a plurality of (meth)acrylic resins may be used. The major component refers to a component having the highest content mass ratio among components included.

It is preferable that the composition for forming an organic layer includes an organic solvent, a surfactant, and a silane coupling agent in addition to the organic compound.

In a case where a plurality of underlying organic layers 38 are provided, that is, in a case where plural sets of combinations of the underlying organic layers 38 and the inorganic layers 40 are provided as described above, the materials of the underlying organic layers 38 may be the same as or different from each other.

The thickness of the underlying organic layer 38 is not limited and can be appropriately set according to components in the composition for forming an organic layer, the support 36 used, and the like.
The thickness of the underlying organic layer 38 is preferably 0.1 to 5 μm. It is preferable that the thickness of the underlying organic layer 38 is 0.1 μm or more from the viewpoint of embedding unevenness of the surface of the support 36, foreign matter attached to the surface, and the like such that the surface of the underlying organic layer 38 can be planarized. It is preferable that the thickness of the underlying organic layer 38 is 5 μm or less from the viewpoints that, for example, cracks of the underlying organic layer 38 can be prevented, the flexibility of the lamination type barrier film 16 can be improved, and the thickness and weight of the barrier film can be reduced.

In a case where a plurality of underlying organic layers 38 are provided, that is, a case where plural sets of combinations of the inorganic layers 40 and the underlying organic layers 38 are provided, the thicknesses of the respective underlying organic layers 38 may be the same as or different from each other.

The underlying organic layer 38 can be formed with a well-known method depending on materials.
For example, the underlying organic layer 38 can be formed with a coating method of applying the above-described composition for forming an organic layer and drying the composition for forming an organic layer. During the formation of the underlying organic layer 38 with the coating method, the dried composition for forming an organic layer is irradiated with ultraviolet rays to polymerize (crosslink) the organic compound in the composition for forming an organic layer.

The inorganic layer 40 is a thin film including an inorganic compound, and is provided on a surface of the underlying organic layer 38. In the lamination type barrier film 16, the inorganic layer 40 mainly exhibits gas barrier properties.
The surface of the support 36 includes a region such as unevenness or shadow of foreign matter to which the inorganic compound is not likely to adhere. By providing the underlying organic layer 38 and forming the inorganic layer 40 thereon, the region to which the inorganic compound is not likely to adhere is covered. Therefore, the inorganic layer 40 can be formed on the formation surface of the inorganic layer 40 without a gap.

A material of the inorganic layer 40 is not limited, and various inorganic compounds that are used for a well-known gas barrier layer consisting of an inorganic compound exhibiting gas barrier properties can be used.
Examples of a material of the inorganic layer 40 include inorganic compounds, for example, a metal oxide such as aluminum oxide, magnesium oxide, tantalum oxide, zirconium oxide, titanium oxide, or indium tin oxide (ITO); a metal nitride such as aluminum nitride; a metal carbide such as aluminum carbide; a silicon oxide such as silicon oxide, silicon oxynitride, silicon oxycarbide, or silicon oxynitride-carbide; a silicon nitride such as silicon nitride or silicon nitride-carbide; a silicon carbide such as silicon carbide; a hydride thereof; a mixture of two or more kinds thereof; and a hydrogen-containing material thereof. In addition, a mixture of two or more kinds of the examples can be used.
In particular, silicon nitride, silicon oxide, silicon oxynitride, aluminum oxide, or a mixture of two or more kinds thereof is preferably used from the viewpoints that transparency is high and excellent gas barrier properties can be exhibited. In particular, a compound including silicon is preferably used, and silicon nitride is more preferably used from the viewpoint that excellent gas barrier properties can be exhibited.

The thickness of the inorganic layer 40 is not particularly limited and can be appropriately set depending on materials such that desired gas barrier properties can be exhibited.
The thickness of the inorganic layer 40 is preferably 10 to 150 nm. It is preferable that the thickness of the inorganic layer 40 is 10 nm or more from the viewpoint that the inorganic layer 40 stably exhibiting sufficient gas barrier performance can be formed. In addition, in a case where the inorganic layer 40 is generally brittle and is excessively thick, breakage, cracking, peeling, or the like may occur. However, by adjusting the thickness of the inorganic layer 40 to be 150 nm or less, the occurrence of breakage can be suppressed.

As described above, in a case where a plurality of inorganic layers 40 are provided, the thicknesses of the inorganic layers 40 may be the same as or different from each other.
In addition, in a case where a plurality of inorganic layers 40 are provided, the materials of the inorganic layers 40 may be the same as or different from each other.

The inorganic layer 40 can be formed with a well-known method depending on materials.
For example, plasma CVD such as capacitively coupled plasma (CCP)-chemical vapor deposition (CVD) or inductively coupled plasma (ICP)-CVD, atomic layer deposition (ALD), sputtering such as magnetron sputtering or reactive sputtering, or various vapor deposition methods such as vacuum deposition can be suitably used.

The protective organic layer 42 is provided as a preferable aspect, and is a layer for protecting the inorganic layer 40 consisting of an organic material. By providing the protective organic layer 42 as the upper most layer of one or more sets of laminated structures of the underlying organic layer 38 and the inorganic layer 40, breakage or the like of the inorganic layer 40 can be prevented.

A material for forming the protective organic layer 42 is not particularly limited, and various well-known organic compounds can be used as in the above-described underlying organic layer 38.
In addition, as the material for forming the protective organic layer 42, a urethane skeleton acrylate polymer such as a polymerizable composition for forming a second organic layer described in paragraphs to of JP2015-171798A may be used. In addition, the composition for forming the protective organic layer 42 may include an additive such as a monomer, an oligomer, or a polymer, a polymerization initiator, and a silane coupling agent, in addition to the urethane skeleton acrylate polymer.

The thickness of the protective organic layer 42 may be appropriately set depending on the material for forming the protective organic layer 42, the inorganic layer 40, and the like. According to an investigation by the present inventors, the thickness of the protective organic layer 42 is preferably 0.1 to 50 μm. By adjusting the thickness of the protective organic layer 42 to be 0.1 μm or more, the inorganic layer 40 can be appropriately protected. In addition, by adjusting the thickness of the protective organic layer 42 to be 50 μm or less, the thickness of the barrier film can be reduced.

For example, as in the underlying organic layer 38, the protective organic layer 42 can be formed with a coating method of applying a composition for forming an organic layer including an organic compound for forming the protective organic layer 42 and drying the composition for forming an organic layer.

As described above, the metal barrier film 14 is bonded to the surface of the first accommodation part 10a of the infusion bag body 24 through the sealant layer 18. On the other hand, the lamination type barrier film 16 is bonded to the other surface of the first accommodation part 10a of the infusion bag body 24 through the sealant layer 18.
The sealant layer 18 bonds the metal barrier film 14 and the lamination type barrier film 16 to the strong sealed portion 12a and the weak sealed portion 12b by thermal welding (heat sealing) such that the first accommodation part 10a of the infusion bag body 24 is surrounded.

Basically, the sealant layer 18 is formed of the same forming material as that of the infusion bag body 24, that is, the resin film 24a and the resin film 24b.
Accordingly, in a case where the infusion bag body 24 is formed of polyethylene (PE), a sheet-shaped material formed of PE is used as the sealant layer 18. In addition, in a case where the infusion bag body 24 is formed of polypropylene (PP), a sheet-shaped material formed of PP is used as the sealant layer 18.
As described above, as the resin film 24a and the resin film 24b, PE, PP, or polyvinyl chloride is suitably used. Accordingly, likewise, as the sealant layer 18, PE, PP, or polyvinyl chloride is suitably used.

In addition, the thickness of the sealant layer 18 is not also limited, and may be appropriately selected depending on the material for forming the sealant layer and the shape, state, or the like of the object such as an infusion bag to be thermally welded such that the object can be reliably thermally welded.
The thickness of the sealant layer 18 is preferably 5 to 150 μm.

As described above, the sealant layer 18 is bonded to the entire surface of the metal layer 32 of the metal barrier film 14 and the laminated barrier layer 46 (protective organic layer 42) of the lamination type barrier film 16.
A method of bonding the metal barrier film 14 and the lamination type barrier film 16 through the sealant layer 18 is not limited, and a well-known method may be used depending on the material for forming the barrier film, that is, the metal layer 32 and the protective organic layer 42 and the material for forming the sealant layer 18.
For example, a method using an adhesive can be used. Considering that the sealant layer 18 is a resin film such as PE, PP, or polyvinyl chloride, a two-liquid curable adhesive is preferably used as the adhesive. In particular, a two-liquid curable urethane adhesive (urethane-based adhesive, polyurethane-based adhesive) is more preferably used.

In the present invention, a method of bonding the sealant layer 18 to the entire surface of the metal barrier film 14 and the lamination type barrier film 16 is not limited.
That is, the sealant layer 18 may be provided on only a thermally welded portion of the infusion bag body 24 of the metal barrier film 14 and the lamination type barrier film 16.

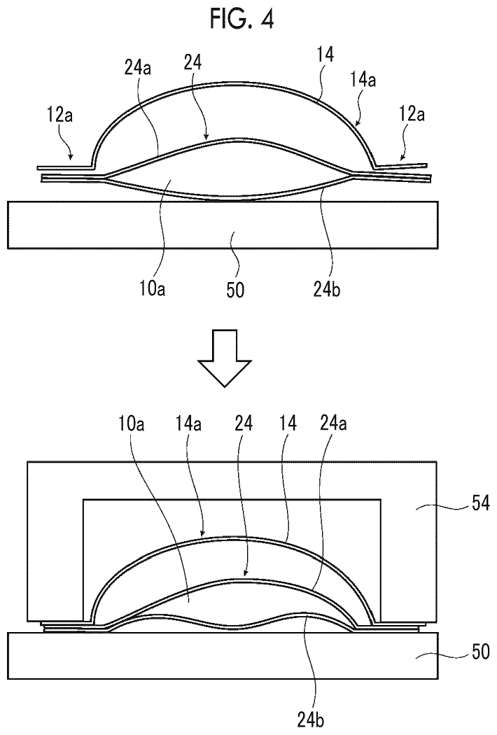

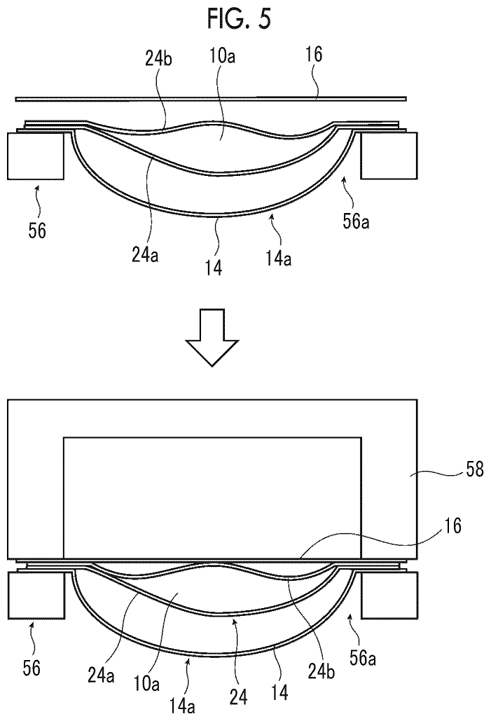

Hereinafter, the method of manufacturing an infusion bag according to the embodiment of the present invention will be described with reference to FIGS. 4 and 5.
Even in FIGS. 4 and 5, in order to simplify the drawings, the sealant layer 18 is not shown.

First, the infusion bag body 24 and the metal barrier film 14 described above are prepared. In the infusion bag body 24, for example, the first accommodation part 10a accommodates the powdered drug, and the second accommodation part 10b accommodates the saline.
Accordingly, the first accommodation part 10a and the second accommodation part 10b are swollen by the content.

Next, as conceptually shown in the upper section of FIG. 4, the first accommodation part 10a is placed on a first placement table 50.
Here, instead of only the first accommodation part 10a, both of the first accommodation part 10a and the second accommodation part 10b may be placed on the first placement table 50. In other words, the first placement table 50 may include not only a region where the first accommodation part 10a is placed but also a region where the second accommodation part 10b is placed. That is, in the manufacturing method according to the embodiment of the present invention, only the first accommodation part 10a or the entire infusion bag body 24 may be placed on the first placement table 50.

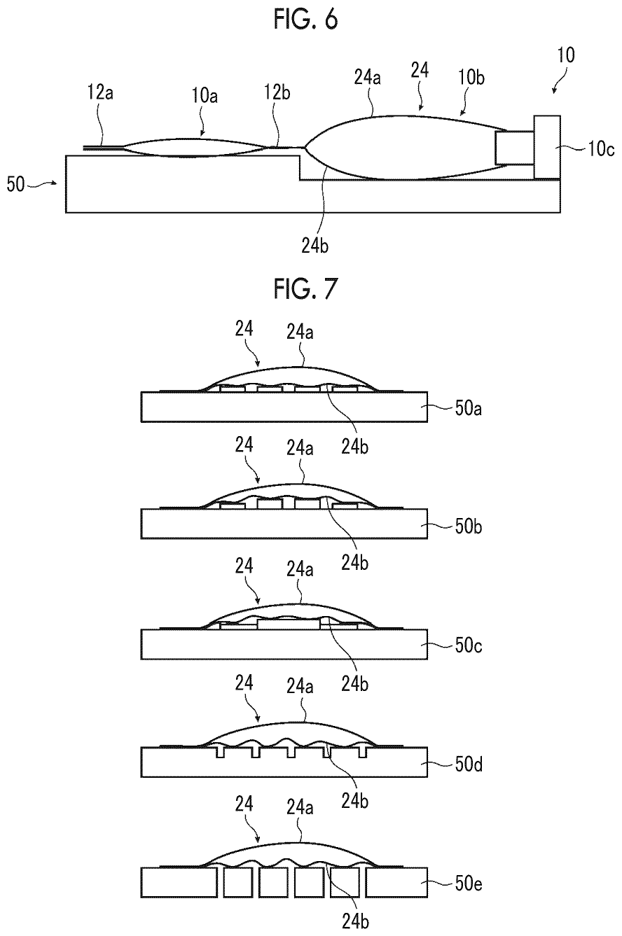

Incidentally, in the infusion bag body 24 including the first accommodation part 10a and the second accommodation part 10b, the thicknesses of the first accommodation part 10a and the second accommodation part 10b are likely to be different due to a difference between the sizes of the accommodation parts, the amount of the content, and the like. In this case, in a case where the entire infusion bag body 24 is placed on the planar first placement table 50, the first accommodation part 10a to which the barrier film is to be bonded cannot be appropriately placed on the first placement table 50.
Therefore, in this case, as conceptually shown in FIG. 6, it is preferable that a level difference is provided between a placement portion (placement surface) of the first accommodation part 10a and a placement portion of the second accommodation part 10b in the first placement table 50. That is, it is preferable that the level difference is provided between the placement portions such that a difference between the thicknesses of the first accommodation part 10a and the second accommodation part 10b can be absorbed and the first accommodation part 10a can be appropriately placed on the first placement table 50. FIG. 6 shows an example where the second accommodation part 10b is thick. Of course, however, the second accommodation part 10b may be thin.
On the other hand, in a case where the thicknesses of the first accommodation part 10a and the second accommodation part 10b are the same or a difference between the thicknesses is small such that the first accommodation part 10a can be appropriately placed on the first placement table 50, the entire infusion bag body 24 may also be placed on the planar first placement table 50 having no level difference.

On the other hand, in a case where only the first accommodation part 10a is placed on the first placement table 50, it is preferable that the second accommodation part 10b is supported using various jigs, support tables, support members and the like such that the first accommodation part 10a can be appropriately placed on the first placement table 50. Alternatively, a worker may manually support the second accommodation part 10b.
Further, using a positioning pin provided in the first placement table 50 and a hole portion provided in the infusion bag body 24 for positioning the infusion bag body 24 described below, the first accommodation part 10a may be held on the first placement table 50 such that the first accommodation part 10a can be appropriately placed.

The state where the first accommodation part 10a can be appropriately placed on the first placement table 50 shows a state where the entire surface of the strong sealed portion 12a and the weak sealed portion 12b that surround the first accommodation part 10a can be pressed against the first placement table 50 by a first heat sealing member 54 described below.

Regarding this point, the same can also be applied to a second placement table 56 described below.
In addition, in the following description unless otherwise specified, the first placement table 50 and the second placement table 56 represent the placement portion (placement region) of the first accommodation part 10a.

The shape of the first placement table 50, that is, the placement portion of the first accommodation part 10a is not limited, and the entire surface is preferably planar.
Here, in the present invention, the first placement table 50 being planar is not limited to being completely planar, and the first placement table 50 may have a small amount of unevenness including unavoidable errors.

A material for forming the first placement table 50 is not limited.
That is, the first placement table 50 can be formed of various well-known materials such as a rubber material, a metal material, or a resin material as long as they have a thermally and mechanically sufficient strength for the thermal welding between the metal barrier film 14 and the strong sealed portion 12a and the weak sealed portion 12b of the first accommodation part 10a through the first heat sealing member 54 described below.
Here, in the first placement table 50 on which the infusion bag body 24 (first accommodation part 10a) is placed, it is preferable that at least a region where the first heat scaling member 54 is received is formed of a material having elasticity that has low thermal conductivity and can absorb unevenness per the first heat sealing member 54, for example, a rubber material or a resin material having elasticity.
In addition, in consideration of the mold releasability of the first accommodation part 10a, the surface of the first placement table 50 may be subjected to a treatment such as a treatment of covering the surface with a mold-releasable material such as Teflon (registered trademark), a treatment of applying mold releasability to the surface, or a treatment of bonding a mold-releasable sheet to the surface. It is preferable that this mold release layer is flexible and thinner, and may be appropriately selected in consideration of a balance with durability.

It is preferable that the first placement table 50 includes a positioning unit for positioning the first accommodation part 10a. The positioning of the first accommodation part 10a may be the positioning of the first accommodation part 10a or the positioning of the second accommodation part 10b. Both of the first accommodation part 10a and the second accommodation part 10b may be positioned.
The positioning unit of the first accommodation part 10a is not limited, and various well-known article positioning units can be used. For example, a method of providing an image such as a line representing the placement position of the first accommodation part 10a (infusion bag body 24) or a method of providing a convex portion such as a wall portion that abuts against an end part of the first accommodation part 10a can be used.

In particular, for example, the method of standing a positioning pin for positioning the first accommodation part 10a on the first placement table 50 and providing a hole portion corresponding to the positioning pin in the infusion bag body 24 such that the positioning pin is inserted into the hole portion of the infusion bag body 24 to position the infusion bag body 24 on the first placement table 50 can be suitably used.
The hole portion for inserting the positioning pin of the first placement table 50 in the infusion bag body 24 can be formed at any position as long as it is a region other than the first accommodation part 10a and the second accommodation part 10b. Here, during the manufacturing of the infusion bag 10, punching for processing the infusion bag in a shape corresponding to a product is typically performed. Accordingly, the hole portion corresponding to the positioning pin that is provided in the infusion bag body 24 may be provided in a region that is cut by the punching of the infusion bag body 24.

Regarding the above-described positioning unit, the same also applies to the bonding of the lamination type barrier film 16 described below.

On the other hand, the metal barrier film 14 is shaped (molded) to form a concave portion 14a such that the metal barrier film 14 the peripheral portion is planar and the region corresponding to the first accommodation part 10a is concave as shown in the upper section of FIG. 4.

Although described below, in the example shown in the drawing, the strong sealed portion 12a and the weak sealed portion 12b that surround the first accommodation part 10a are thermally welded to the planar peripheral portion of the metal barrier film 14 (sealant layer 18). As a result, the metal barrier film 14 and the infusion bag body 24 adhere to each other to surround the first accommodation part 10a.
This thermal welding is performed, for example, by laminating the strong sealed portion 12a and the weak sealed portion 12b that surround the first accommodation part 10a and the planar peripheral portion of the metal barrier film 14 and thermally fusing the laminate to the first placement table 50 through the first heat sealing member 54.

Here, the first accommodation part 10a is placed on the planar first placement table 50. Accordingly, on the lower side abutting against the first placement table 50, there is no portion protruding to the lamination type barrier film 16 side from the plane to which the lamination type barrier film 16 described below is bonded, that is, from the bonding surface of the lamination type barrier film 16. Therefore, the upper side opposite to the first placement table 50 is swollen by the pressing of the peripheral portion by the first heat sealing member 54. In the following description, the state where “there is no portion protruding to the lamination type barrier film 16 side from the plane to which the lamination type barrier film 16 is bonded” will also be simply referred to as “being planar”.
Accordingly, in the manufacturing method according to the embodiment of the present invention, the metal barrier film 14 that covers the first accommodation part 10a is shaped to form the concave portion 14a having a size where the first accommodation part 10a that is swollen upward can be accommodated. It is preferable that the concave portion 14a is formed to rise outside of inner end parts of the strong sealed portion 12a and the weak sealed portion 12b that surround the first accommodation part 10a.

A method of shaping (molding method) the metal barrier film 14 having the concave portion 14a and the planar periphery is not limited, and various well-known methods can be used.
Examples of the molding method include vacuum molding and embossing molding. Alternatively, using a molding method, for example, blow molding or injection molding such as in-mold molding, the metal barrier film 14 having the concave portion 14a and the planar periphery where the support 30 and the metal layer 32 are laminated may be molded. Alternatively, using the metal layer 32 that is shaped in advance by press molding or the like, the metal barrier film 14 having the concave portion 14a and the planar periphery may be molded by insert molding.

Next, the metal barrier film 14 where the concave portion 14a is formed is laminated on the infusion bag body 24 such that the concave portion 14a accommodates the first accommodation part 10a and the planar peripheral portion abuts against the strong sealed portion 12a and the weak sealed portion 12b. That is, the first accommodation part 10a is covered with the metal barrier film 14 such that the concave portion 14a accommodates the first accommodation part 10a and the planar peripheral portion abuts against the strong sealed portion 12a and the weak sealed portion 12b.
In this case, the metal barrier film 14 is laminated on the infusion bag body 24 such that the entire area of the rising portion of the concave portion 14a is positioned outside of inner end parts of the strong sealed portion 12a and the weak sealed portion 12b that surround the first accommodation part 10a.

In the manufacturing method according to the embodiment of the present invention, the infusion bag body 24 may be laminated on the first placement table 50 after laminating the metal barrier film 14 where the concave portion 14a is formed on the first accommodation part 10a of the infusion bag body 24.

In a case where the metal barrier film 14 is laminated on the infusion bag body 24, as conceptually shown in the lower section of FIG. 4, a laminate portion of the strong sealed portion 12a and the weak sealed portion 12b of the first accommodation part 10a and the metal barrier film 14 (sealant layer 18) is thermally fused by the first heat sealing member 54.
As a result, the metal barrier film 14 and the infusion bag body 24 are bonded by thermal welding to surround the first accommodation part 10a.

The thermal welding between the metal barrier film 14 and the infusion bag body 24 (first accommodation part 10a) may be performed at once on the whole periphery, or may be dividedly performed multiple times.
For example, in the rectangular first accommodation part 10a in the example shown in the drawing, four sides may be thermally welded at once to the rectangular frame-shaped first heat sealing member 54. Alternatively, the thermal welding of the four sides of the rectangular first accommodation part 10a may be performed by performing thermal welding for each of the sides, that is, four times in total. Alternatively, the thermal welding of the four sides may be performed by performing thermal welding for every two sides facing each other in the rectangle, that is, two times in total. Alternatively, using an L-shaped first heat sealing member, the thermal welding of the four sides may be performed by performing thermal welding for every two sides adjacent to each other in the rectangle, that is, two times in total.

However, in consideration of the productivity, the work efficiency, and the like, it is preferable that the thermal welding between the metal barrier film 14 and the infusion bag body 24 is performed at once on the whole periphery using the rectangular frame-shaped first heat sealing member 54 or the like.
Regarding the above-described point, the same also applies to the thermal welding between the lamination type barrier film 16 and the infusion bag body 24 (first accommodation part 10a).

Here, in the infusion bag 10 manufactured using the manufacturing method according to the embodiment of the present invention, in the first accommodation part 10a that is the to-be-barriered accommodation part according to the embodiment of the present invention, one surface is covered with the metal barrier film 14, and the other surface is covered with the lamination type barrier film 16.
Accordingly, in the first accommodation part 10a, the surface covered with the lamination type barrier film 16 is the surface on the first placement table 50 side.

As described above, in the first accommodation part 10a where the infusion bag body 24 is placed on the first placement table 50 and the periphery is pressed by the first heat sealing member 54, the upper side, that is, the side opposite to the first placement table 50 is largely swollen. That is, the first accommodation part 10a is placed on the planar first placement table 50. Therefore, by forming the first placement table 50 of the first accommodation part 10a in one convex shape, the volume of the content is absorbed.
The areas of the resin film 24a and the resin film 24b forming the first accommodation part 10a are the same. That is, in the first accommodation part 10a, the surface covered with the metal barrier film 14 has the same area as the surface covered with the lamination type barrier film 16.
Therefore, in the first accommodation part 10a, the surface on the first placement table 50 side, that is, the surface covered with the lamination type barrier film 16 has a plurality of uneven portions to absorb a difference from the large convex portion on the upper side. In other words, the surface of the first accommodation part 10a covered with the lamination type barrier film 16 has a wave-like shape, that is, a shape including a plurality of inflection points changing from a convex portion to a concave portion in a cross section orthogonal to a plane direction.

However, the infusion bag body 24 is placed on the first placement table 50. That is, in the first accommodation part 10a, the surface covered with the lamination type barrier film 16 is placed and supported on the first placement table 50.
Accordingly, the unevenness of the surface of the first accommodation part 10a covered with the lamination type barrier film 16 does not exceed the first placement table 50. As a result, even in a case where the surface of the first accommodation part 10a covered with the lamination type barrier film 16 has a plurality of uneven portions, there is no portion protruding to the lamination type barrier film 16 side from the plane to which the lamination type barrier film 16 is bonded, that is, the entire surface is planar.

Next, as conceptually shown in the upper section of FIG. 5, the infusion bag body 24 to which the metal barrier film 14 is thermally welded is placed on the second placement table 56.
As in the first placement table 50, the entire infusion bag body 24 may be placed on the second placement table 56, or only the first accommodation part 10a may be placed on the second placement table 56. In addition, the absorption and the like of the difference between the thicknesses of the first accommodation part 10a and the second accommodation part 10b and the method and the like of placing and supporting the infusion bag body 24, that is, the first accommodation part 10a and/or the second accommodation part 10b on the second placement table 56 are the same as those of the first placement table 50.
As described above, in the following description unless otherwise specified, the second placement table 56 represents the placement portion (placement region) of the first accommodation part 10a.
The second placement table 56 includes a space 56a into which the concave portion 14a of the metal barrier film 14 is inserted, and supports the planar peripheral portion of the metal barrier film 14 and the strong sealed portion 12a and the weak sealed portion 12b of the first accommodation part 10a of the infusion bag body 24.
Accordingly, in the infusion bag body 24 to which the metal barrier film 14 is thermally welded, the concave portion 14a of the metal barrier film 14 is inserted into the space 56a such that the metal barrier film 14 side faces the second placement table 56, and the planar peripheral portion of the metal barrier film 14 and the strong sealed portion 12a and the weak sealed portion 12b of the first accommodation part 10a of the infusion bag body 24 are placed on the second placement table 56.

The shape of the second placement table 56 is not limited. That is, various shapes can be used as long as the second placement table 56 includes the space 56a into which the concave portion 14a of the metal barrier film 14 is inserted, and can support the planar peripheral portion of the metal barrier film 14 and the strong sealed portion 12a and the weak scaled portion 12b of the first accommodation part 10a of the infusion bag body 24.
Accordingly, the second placement table 56 may have a frame shape such as a rectangular frame shape that supports the planar peripheral portion of the metal barrier film 14 and the strong sealed portion 12a and the weak sealed portion 12b of the first accommodation part 10a of the infusion bag body 24. Alternatively, the second placement table 56 may form a concave portion for inserting the concave portion 14a of the metal barrier film 14 into a plate-shaped member.

In a case where the infusion bag body 24 into which the metal barrier film 14 is thermally welded is placed on the second placement table 56, as shown in the upper section of FIG. 5, the lamination type barrier film 16 is placed to cover the first accommodation part 10a.
Next, as conceptually shown in the lower section of FIG. 5, the laminate portion of the strong scaled portion 12a and the weak sealed portion 12b of the first accommodation part 10a and the metal barrier film 14 (sealant layer 18) is thermally fused through a second heat scaling member 58.
As a result, the lamination type barrier film 16 and the infusion bag body 24 are bonded by thermal welding to surround the first accommodation part 10a.

In this case, it is preferable that the infusion bag body 24 to be placed on the second placement table 56 is positioned. In this case, the positioning unit is not limited, and it is preferable that a positioning pin provided in the second placement table 56 is used for positioning as in the first placement table 50. A hole portion of the infusion bag body 24 corresponding to the positioning pin provided in the second placement table 56 may be different from the hole portion corresponding to the positioning pin of the first placement table 50. However, it is preferable that the hole portion of the infusion bag body 24 corresponding to the positioning pin provided in the second placement table 56 is the same as the hole portion corresponding to the positioning pin of the first placement table 50.
In addition, the thermal welding between the lamination type barrier film 16 and the infusion bag body 24 may be performed at once on the whole periphery, or may be dividedly performed multiple times. It is preferable that the thermal welding is performed at once on the whole periphery as in the thermal welding between the metal barrier film 14 and the infusion bag body 24.

Here, as described above, in the manufacturing method according to the embodiment of the present invention, the thermal welding between the metal barrier film 14 and the infusion bag body 24 is performed to surround the first accommodation part 10a by placing the first accommodation part 10a on the first placement table 50, laminating the metal barrier film 14 having the concave portion 14a, and thermally fusing the laminate through the first heat sealing member 54.
As a result, in the manufacturing method according to the embodiment of the present invention, the surface covered with the lamination type barrier film 16 in the first accommodation part 10a that is the to-be-barriered accommodation part according to the embodiment of the present invention is maintained to be planar by the first placement table 50, the side covered with the metal barrier film 14 is formed in one large convex shape. As a result, the volume of the content is absorbed.
As a result, in the manufacturing method according to the embodiment of the present invention, the surface that is covered with the lamination type barrier film 16 in the first accommodation part 10a and is thermally welded (bonded) to surround the first accommodation part 10a has no portion protruding to the lamination type barrier film 16 side from the plane to which the lamination type barrier film 16 is bonded, that is, can be maintained to be planar.

Therefore, in the manufacturing method according to the embodiment of the present invention, the lamination type barrier film 16 including the weak inorganic layer 40 is laminated on the planar first accommodation part 10a, and can be thermally welded to the infusion bag body 24 to surround the first accommodation part 10a. Therefore, the damage of the inorganic layer 40 can be prevented.
Further, in order to laminate lamination type barrier film 16 on a plane, the first accommodation part 10a does not need to be pressed to be planarized. Therefore, the heat of the second heat sealing member 58 is not transferred to a member that presses the first accommodation part 10a, and the damage of the lamination type barrier film 16 and the deterioration of the content of the first accommodation part 10a caused by heat can be prevented.

In the above-described example, the first placement table 50 on which the infusion bag body 24 (first accommodation part 10a) is placed during the thermal welding of the metal barrier film 14, that is, the placement surface of the infusion bag body 24 is planar, but the present invention is not limited thereto.
For example, the first placement table 50 may have a convex shape including a peripheral flat portion and a convex portion rising from the flat portion. In the first placement table 50, during the thermal fusion of the metal barrier film 14, this flat portion is a region against which the first heat sealing member 54 abuts, and is a region that is also so-called a seal-receiving region. Regarding this point, the same also applies to the subsequent configuration including a concave portion.
In this case, it is preferable that the convex portion of the first placement table 50 rises inside of inner end parts of the strong sealed portion 12a and the weak sealed portion 12b, in particular, rises from a position 1 mm or more inside thereof. That is, on the outside of the rising portion of the convex portion of the first placement table 50, that is, the flat portion, it is preferable that the metal barrier film 14 is bonded to the infusion bag body 24 to surround the first accommodation part 10a.
In particular, it is preferable that the convex portion of the first placement table 50 rises from a position G mm inside of the inner end parts of the strong sealed portion 12a and the weak sealed portion 12b, and in a case where the height of the convex portion is represented by H mm, the maximum thickness of the first accommodation part 10a is represented by B mm, and the distance from the position of the maximum thickness of the first accommodation part 10a to a position closest to the end part of the first accommodation part 10a (inner end part of the sealed portion) is represented by C mm, “H/G<B/2C” is satisfied.
In the present invention, “the maximum thickness of the first accommodation part 10a” refers to the maximum thickness of the first accommodation part 10a in a case where the first accommodation part 10a (infusion bag body 24) is placed on the first placement table 50 at the same attitude as that during the thermal welding of the metal barrier film 14.
With the above-described configuration, even in a case where the first placement table 50 is convex, the entire surface of the first accommodation part 10a on the lamination type barrier film 16 side can be maintained to be planar.
In addition, the height of the convex portion of the first placement table 50 is preferably half or less and more preferably ⅕ or less of the maximum thickness of the first accommodation part 10a.

In addition, the first placement table 50 may have a convex shape including a peripheral flat portion and a concave portion recessed from the flat portion.
In a case where the first placement table 50 is concave, on the outside of the recess start portion of the concave portion, that is, the flat portion, it is preferable that the metal barrier film 14 is bonded to the infusion bag body 24 to surround the first accommodation part 10a. In this case, in particular, it is preferable that the thermal welding between the lamination type barrier film 16 and the infusion bag body 24 is performed through the rectangular frame-shaped second heat sealing member, and in a case where the maximum depth of the concave portion of the first placement table 50 is represented by L [mm] and the inner distance between short sides of the rectangular frame of the second heat sealing member is represented by W [mm],

$$L / W \leq 0.035$$

is satisfied.

With the above-described configuration, even in a case where the first placement table 50 is concave, the entire surface of the first accommodation part 10a on the lamination type barrier film 16 side can be maintained to be planar.

Note that, in the first placement table 50, even in a case where the placement region of the first accommodation part 10a is convex or concave, it is preferable that the rising portion of the convex portion or the recess start portion of the concave portion and the convex or concave shape does not have a corner portion such that a change on the surface is smooth.

In addition, as the shape of the placement portion of the first accommodation part 10a in the first placement table, various shapes can be used as long as it can maintain the state where the surface of the first accommodation part 10a to which the lamination type barrier film 16 is bonded has no portion protruding to the lamination type barrier film 16 side from the plane to which the lamination type barrier film 16 is bonded.
Examples of the shape include a shape including a plurality of convex portions having the same height as in a first placement table 50a shown in the uppermost section (first section) of FIG. 7, a shape including a plurality of convex portions having different heights as in a first placement table 50b shown in the second section of FIG. 7, and a shape where the height varies stepwise as in a first placement table 50c shown in the third section of FIG. 7.
In addition, as the shape of the placement portion of the first accommodation part 10a in the first placement table, a shape including a plurality of hole portions on a plane as in a first placement table 50d shown in the fourth section of FIG. 7, and a shape including a plurality of through-holes in a flat plate as in a first placement table 50e shown in the fifth section of FIG. 7 can also be used. In the shape including a plurality of through-holes as in the first placement table 50e, air comes out from the through-holes in a case where the whole periphery of the sealed portion that surround the first accommodation part 10a placed on the first placement table is bonded at once. Therefore, a redundant tension can be prevented from being applied to the resin film 24b.

That is, in the manufacturing method according to the embodiment of the present invention, the first placement table can adopt various shapes as long as, in a case where first accommodation part 10a is placed, the surface (lower surface in the drawing) of the first accommodation part on the first placement table side has no portion protruding to the lamination type barrier film 16 side from the plane to which the lamination type barrier film 16 is bonded, that is, can be maintained to be planar.

For example, the first placement table may include a flat portion on the periphery, that is, a flat portion called a seal-receiving region against which the first heat sealing member 54 abuts during the thermal fusion of the metal barrier film 14 as described above, and may include one or a plurality of hole portions (concave portions) where the inside of the seal-receiving region is recessed downward from the seal-receiving surface. This hole portion can act as a buffer portion for allowing air expanded during thermal fusion to come out.
Here, the shape of the hole portion is not limited and may be a groove. In a case where the hole portion is a groove, the groove may be linear or curved. In a case where the hole portion has a size that is less than 50 t [mm] with respect to the thickness t [mm] of the resin film 24a and the resin film 24b forming the infusion bag body 24, the depth is not limited, and the hole portion may be a through-hole. The size of the hole portion refers to the maximum length of the hole portion, that is, the diameter of a circle inscribed in the hole portion. Note that, in a case where the hole portion has a groove shape, the size of the hole portion refers to the width of the groove.
In a case where the line width exceeds 50 t [mm], the depth of the hole portion is preferably 0.07E [mm] or less, where E represents the distance from the centroid of a cross sectional shape of the hole portion to the inside of the seal-receiving region closest to the centroid.

In addition, the first placement table may include one or a plurality of convex portions that are convex from the seal-receiving surface to the inside of the seal-receiving region (peripheral flat portion).
In this case, it is preferable that the convex portion has a shape where the top surface (upper surface) of the convex shape is present inside a virtual spindle shape that has an apex immediately above the centroid of the shape of the inside of the seal-receiving region and has a bottom side having the shape of the inside of the seal-receiving region. In other words, in a case where a perpendicular line perpendicular to the seal-receiving surface is assumed from the centroid of a two-dimensional shape of the inside of the seal-receiving region and a spindle shape having an apex on the perpendicular line is assumed, it is preferable that the convex portion has the top surface having a convex shape in the spindle shape. In addition, it is preferable that all of the convex portions are included in the virtual spindle shape.
In this case, the top surface of the convex portion does not need to be parallel to the seal-receiving surface, and may be a curved surface or a discontinuous surface.
In a case where the height of the convex portion is represented by H [mm] and the length of a short side of the seal-receiving region is represented by F [mm], it is preferable that the height of the apex of the virtual spindle shape is lower than 0.2F/H [mm].

In the above-described example, the bonding between the barrier film and the infusion bag body 24 is performed by thermal welding (heat sealing) using the sealant layer 18, but the present invention is not limited thereto.
That is, in the manufacturing method according to the embodiment of the present invention, the bonding between the barrier film and the infusion bag body 24 may be performed, for example, using a bonding agent such as an adhesive or a pressure sensitive adhesive. In addition, among the metal barrier film 14 and the lamination type barrier film 16, one may be bonded to the infusion bag body 24 using a bonding agent and the other one may be bonded to the infusion bag body 24 by thermal welding.
However, in consideration of the sanitation, safety, and the like of the infusion bag, in the manufacturing method according to the embodiment of the present invention, the thermal welding as in the example shown in the drawing is suitably used for the bonding between the barrier film and the infusion bag body 24.

Hereinbefore, the method of manufacturing an infusion bag according to the embodiment of the present invention has been described in detail. However, the present invention is not limited to the above-described aspects and various improvements and changes may be made within a range not departing from the scope of the present invention.

The present invention is suitably applicable to manufacturing of various infusion bags.

### Explanation of References

10: infusion bag
10a: first accommodation part
10b: second accommodation part
10c: port
12a: strong sealed portion
12b: weak sealed portion
14: metal barrier film
16: lamination type barrier film
18: sealant layer
24: infusion bag body
24a, 24b: resin film
30, 36: support
32: metal layer
38: underlying organic layer
40: inorganic layer
42: protective organic layer
46: laminated barrier layer
50, 50a, 50b, 50c, 50d, 50c: first placement table
54: first heat scaling member
56: second placement table
56a: space
58: second heat sealing member

What is claimed is:

1. A method of manufacturing an infusion bag including an infusion bag body that is sealed with a strong sealed portion, includes two accommodation parts separated by a weak sealed portion, and accommodates a content in at least one of the accommodation parts, a metal barrier film that covers one surface of a to-be-barriered accommodation part as one of the accommodation parts for accommodating the content and includes a metal layer, and a lamination type barrier film that covers another surface of the to-be-barriered accommodation part and has a laminated structure of an organic layer and an inorganic layer, the method comprising:
a step of using the metal barrier film having a peripheral portion that is planar and having a concave portion that is shaped in a shape accommodating the to-be-barriered accommodation part to place the to-be-barriered accommodation part of the infusion bag body and the strong sealed portion and the weak sealed portion that surround the to-be-barriered accommodation part on a first placement table and to cover the to-be-barriered accommodation part with the concave portion of the metal barrier film;
a step of bonding the metal barrier film to the infusion bag body to surround the to-be-barriered accommodation part;
a step of placing the strong sealed portion and the weak sealed portion that surround the to-be-barriered accommodation part of the infusion bag body on a second placement table having a space into which the concave portion of the metal barrier film is inserted such that the metal barrier film side faces the second placement table side, and covering a surface of the to-be-barriered accommodation part opposite to the metal barrier film with the lamination type barrier film; and
a step of bonding the lamination type barrier film to the infusion bag body to surround the to-be-barriered accommodation part.

2. The method of manufacturing an infusion bag according to claim 1,
wherein at least one of the bonding of the metal barrier film and the infusion bag body or the bonding of the lamination type barrier film and the infusion bag body is performed by welding.

3. The method of manufacturing an infusion bag according to claim 1,
wherein the first placement table is planar.

4. The method of manufacturing an infusion bag according to claim 1,
wherein the first placement table includes a peripheral flat portion and a convex portion rising from the flat portion, and
the metal barrier film is bonded to the infusion bag body to surround the to-be-barriered accommodation part in the flat portion.

5. The method of manufacturing an infusion bag according to claim 1,
wherein the first placement table includes a peripheral flat portion and a concave portion recessed from the flat portion,
the bonding of the lamination type barrier film and the infusion bag body is performed using a rectangular frame such that the metal barrier film is bonded to the infusion bag body to surround the to-be-barriered accommodation part in the flat portion, and
in a case where a maximum depth of the concave portion of the first placement table is represented by L [mm] and an inner distance between short sides of the rectangular frame is represented by W [mm], the following expression
$$L / W \leq 0.035$$
is satisfied.

6. The method of manufacturing an infusion bag according to claim 1,
wherein the metal barrier film having the concave portion is molded by any one of vacuum molding, embossing molding, blow molding, or injection molding.

7. The method of manufacturing an infusion bag according to claim 1,
wherein a pin for positioning the infusion bag body is provided on at least one of the first placement table or the second placement table.

8. The method of manufacturing an infusion bag according to claim 2,
wherein the first placement table is planar.

9. The method of manufacturing an infusion bag according to claim 2,
wherein the first placement table includes a peripheral flat portion and a convex portion rising from the flat portion, and
the metal barrier film is bonded to the infusion bag body to surround the to-be-barriered accommodation part in the flat portion.

10. The method of manufacturing an infusion bag according to claim 2,
wherein the first placement table includes a peripheral flat portion and a concave portion recessed from the flat portion,
the bonding of the lamination type barrier film and the infusion bag body is performed using a rectangular frame such that the metal barrier film is bonded to the infusion bag body to surround the to-be-barriered accommodation part in the flat portion, and
in a case where a maximum depth of the concave portion of the first placement table is represented by L [mm] and an inner distance between short sides of the rectangular frame is represented by W [mm], the following expression
$$L / W \leq 0.035$$
is satisfied.

11. The method of manufacturing an infusion bag according to claim 2,
wherein the metal barrier film having the concave portion is molded by any one of vacuum molding, embossing molding, blow molding, or injection molding.

12. The method of manufacturing an infusion bag according to claim 2,
wherein a pin for positioning the infusion bag body is provided on at least one of the first placement table or the second placement table.

13. The method of manufacturing an infusion bag according to claim 3,
wherein the first placement table includes a peripheral flat portion and a convex portion rising from the flat portion, and
the metal barrier film is bonded to the infusion bag body to surround the to-be-barriered accommodation part in the flat portion.

14. The method of manufacturing an infusion bag according to claim 3,
wherein the first placement table includes a peripheral flat portion and a concave portion recessed from the flat portion,
the bonding of the lamination type barrier film and the infusion bag body is performed using a rectangular frame such that the metal barrier film is bonded to the infusion bag body to surround the to-be-barriered accommodation part in the flat portion, and
in a case where a maximum depth of the concave portion of the first placement table is represented by L [mm] and an inner distance between short sides of the rectangular frame is represented by W [mm], the following expression
$$L / W \leq 0.035$$
is satisfied.

15. The method of manufacturing an infusion bag according to claim 3,
wherein the metal barrier film having the concave portion is molded by any one of vacuum molding, embossing molding, blow molding, or injection molding.

16. The method of manufacturing an infusion bag according to claim 3,
wherein a pin for positioning the infusion bag body is provided on at least one of the first placement table or the second placement table.

17. The method of manufacturing an infusion bag according to claim 4,
wherein the metal barrier film having the concave portion is molded by any one of vacuum molding, embossing molding, blow molding, or injection molding.

18. The method of manufacturing an infusion bag according to claim 4,
wherein a pin for positioning the infusion bag body is provided on at least one of the first placement table or the second placement table.

19. The method of manufacturing an infusion bag according to claim 5,
wherein the metal barrier film having the concave portion is molded by any one of vacuum molding, embossing molding, blow molding, or injection molding.

20. The method of manufacturing an infusion bag according to claim 5,
wherein a pin for positioning the infusion bag body is provided on at least one of the first placement table or the second placement table.
